(19) United States
(12) Patent Application Publication
(10) Pub. No.: US 2017/0067328 A1
(43) Pub. Date: Mar. 9, 2017

(54) DOWNHOLE TOOL WITH A DISSOLVABLE COMPONENT

(71) Applicant: TEAM OIL TOOLS, LP, The Woodlands, TX (US)

(72) Inventors: Stephen J. Chauffe, The Woodlands, TX (US); Carl Martin, The Woodlands, TX (US); Justin Kellner, Adkins, TX (US)

(21) Appl. No.: 15/255,420

(22) Filed: Sep. 2, 2016

Related U.S. Application Data
(60) Provisional application No. 62/214,260, filed on Sep. 4, 2015.

(51) Int. Cl. E21B 43/26; E21B 29/02; C09K 8/62; C04B 35/56; C09K 8/80; E21B 43/267; C04B 35/14

(52) U.S. Cl. CPC E21B 43/261; E21B 43/267; E21B 29/02; C04B 35/14; C04B 35/56; C09K 8/80; C09K 8/62; E21B 2034/007

(57) ABSTRACT

A downhole tool and a method for fracturing a well, of which the method includes running downhole tool into a wellbore, the downhole tool including a ball seat including a dissolvable material and a protective layer that substantially prevents the dissolvable material from dissolving, and deploying an obstructing member into the wellbore. The obstructing member is caught by the ball seat. The method also includes performing one or more fracturing operations while the obstructing member engages the ball seat. Performing the one or more fracturing operations comprises introducing an abrading fluid to the ball seat, and the abrading fluid erodes at least a portion of the protective layer from the ball seat. The method also includes, after eroding the at least a portion of the protective layer, causing the dissolvable material of the ball seat to at least partially dissolve.

### CROSS-REFERENCE TO RELATED APPLICATIONS

This application claims priority to U.S. Provisional Patent Application No. 62/214,260, which was filed on Sep. 4, 2015 and is incorporated herein by reference in its entirety.

### BACKGROUND

In the oilfield, fracturing (or “fracking”) operations are employed to open preferential flowpaths in a subterranean formation, which may allow for economic access to and production from unconventional hydrocarbon reserves. In such fracturing operations, in general, a fracturing tool such as a frac plug or frac sleeve is deployed into the wellbore, the tool is then plugged, e.g., by deploying a ball onto a ball seat of the tool, and then pressurized fluid is deployed. The pressurized fluid can include water, proppants, acids, etc. The pressurized fluid meets the plugged tool and is diverted outward into the targeted formation. There are many variations on this process, with the foregoing being merely a simplified introduction.

Further, multiple formations at different depths may be fractured along a single well. This is referred to as multi-stage fracturing. Generally, multiple fracturing tools are positioned at intervals along the well. The operator then drops a ball, which passes by the shallower fracturing tools, until landing on the ball seat of the deepest tool, thereby plugging the deepest tool. Pressurized fluid is then injected into the formation immediately above the deepest tool. When treatment is complete, the next deepest tool is plugged, and the process is repeated, with injection occurring in the next deepest formation, isolated from the subjacent, deepest formation. This can be repeated for as many plugs/valves as are provided so as to treat the formations individually.

In such operations, the plugs and/or sleeves may obstruct the wellbore in order to perform their function of diverting the pressurized fluid into the wellbore. At some point, however, such obstruction is removed, e.g., to enable production of fluids from the formation. Typically, this is accomplished by flowing back (e.g., reversing fluid flow) to remove the ball from the tool, and then milling out the ball seat to return the tool to full bore diameter. However, milling out such ball seats can be costly and time-consuming.

### SUMMARY

Embodiments of the disclosure may include a method for fracturing a well. The method includes running downhole tool into a wellbore, the downhole tool including a ball seat including a dissolvable material and a protective layer that substantially prevents the dissolvable material from dissolving, and deploying an obstructing member into the wellbore. The obstructing member is caught by the ball seat. The method also includes performing one or more fracturing operations while the obstructing member engages the ball seat. Performing the one or more fracturing operations comprises introducing an abrading fluid to the ball seat, and the abrading fluid erodes at least a portion of the protective layer from the ball seat. The method also includes, after eroding the at least a portion of the protective layer, causing the dissolvable material of the ball seat to at least partially dissolve.

Embodiments of the disclosure also include a downhole tool. The downhole tool includes a dissolvable component including a dissolvable material and at least one protective outer layer at least partially enveloping the dissolvable material. The at least one protective outer layer is configured to be eroded by an abrading fluid so as to allow introduction of the abrading fluid to the dissolvable material. The dissolvable material dissolves in the presence of the abrading fluid.

Embodiments of the disclosure further include a method of removing a component in a wellbore. The method includes deploying the component into the wellbore, the component including a dissolvable material and a protective layer at least partially enveloping the dissolvable material. The protective layer substantially prevents the dissolvable material from dissolving until the protective layer is at least partially removed by an abrading fluid. The method also includes pumping the abrading fluid into the wellbore to remove at least a portion the protective layer of the component, and removing the component by dissolving the dissolvable material exposed by removing the at least a portion of the protective layer.

The foregoing summary is intended merely to introduce some aspects of the following disclosure and is thus not intended to be exhaustive, identify key features, or in any way limit the disclosure or the appended claims.

### BRIEF DESCRIPTION OF THE DRAWINGS

The present disclosure may best be understood by referring to the following description and accompanying drawings that are used to illustrate embodiments of the invention. In the drawings:

FIG. 1 illustrates a side, half-sectional view of a downhole tool including a dissolvable ball seat, according to an embodiment.

FIG. 2 illustrates a side, sectional view of the ball seat, according to an embodiment.

FIG. 3 illustrates a flowchart of a method for fracturing a well, according to an embodiment.

FIG. 4 illustrates a side, half-sectional view of the downhole tool showing an abrading fluid meeting the ball seat, according to an embodiment.

FIG. 5 illustrates a side, half-sectional view of the downhole tool, after the ball seat dissolves, according to an embodiment.

FIG. 6A illustrates a side, cross-sectional view of another downhole tool having a dissolvable ball seat, according to an embodiment.

FIG. 6B illustrates a side, cross-sectional view of the downhole tool of FIG. 6A with an obstructing member caught in the dissolvable ball seat, according to an embodiment.

FIG. 7 illustrates a side, half-sectional view of another downhole tool having a dissolvable ball seat, according to an embodiment.

FIG. 8 illustrates a side, half-sectional view of yet another downhole tool having a dissolvable ball seat, according to an embodiment.

### DETAILED DESCRIPTION

The following disclosure describes several embodiments for implementing different features, structures, or functions of the invention. Embodiments of components, arrangements, and configurations are described below to simplify the present disclosure; however, these embodiments are provided merely as examples and are not intended to limit the scope of the invention. Additionally, the present disclosure may repeat reference characters (e.g., numerals) and/or letters in the various embodiments and across the Figures provided herein. This repetition is for the purpose of simplicity and clarity and does not in itself dictate a relationship between the various embodiments and/or configurations discussed in the Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the embodiments presented below may be combined in any combination of ways, e.g., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. In addition, unless otherwise provided herein, “or” statements are intended to be non-exclusive; for example, the statement “A or B” should be considered to mean “A, B, or both A and B.”

Embodiments of the present disclosure may provide a downhole tool that has a dissolvable component. The dissolvable component may be a ball seat, mandrel, sliding sleeve, or another component of the tool. As an example, the dissolvable ball seat will be described in relation to a frac sleeve for use in a fracking operation; however, the dissolvable ball seat may also be used in other downhole tools as well. Further, the dissolvable component may be a fluid restriction or obstructing member, such as a ball or a dart. In some embodiments, the dissolvable component includes a protective layer, such as a surface-treated, outer layer of the ball seat, or a coating applied to the ball seat. The protective layer may be a non-permeable and a non-dissolving layer, which substantially prevents the dissolvable material from dissolving until eroded away by a predetermined abrasive material or agitating material, e.g., as contained in an “abrading fluid” as discussed below. The abrading fluid may also function as the fluid injected into the formation.

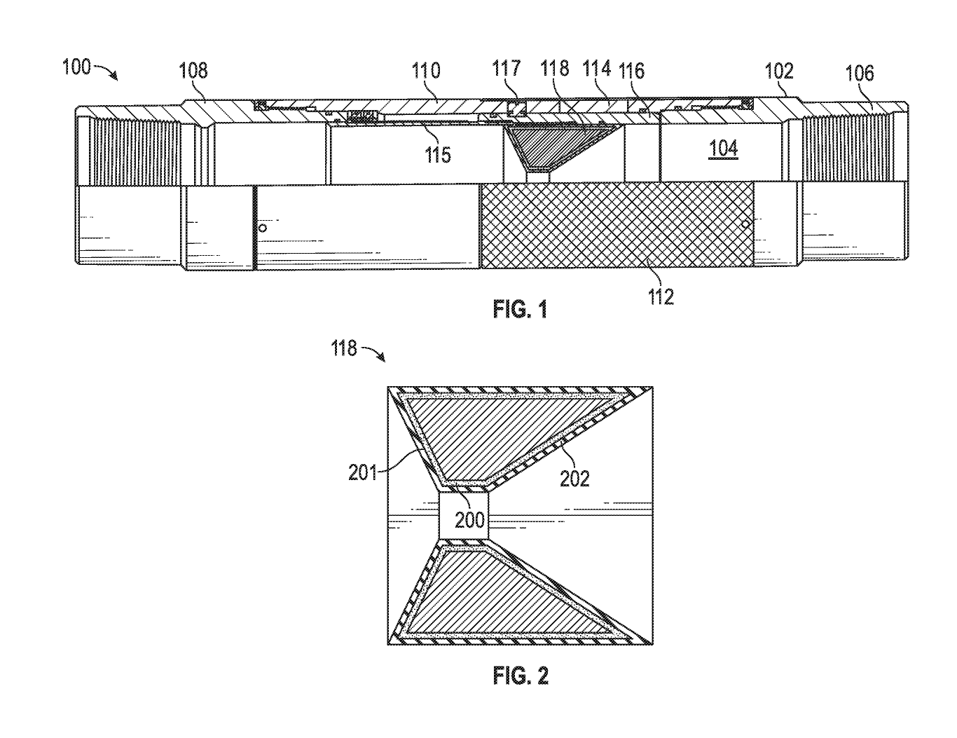

Turning now to the specific, illustrated embodiments, FIG. 1 depicts a side, half-sectional view of a downhole tool 100, according to an embodiment. The downhole tool 100 may generally include a body 102, which may define a bore 104 therethrough. In a specific embodiment, the body 102 may include an upper sub 106, a lower sub 108 coaxial with and spaced apart from the upper sub 106, and an outer housing 110 connected to and extending between the upper and lower subs 106, 108. A cover 112 may be positioned at least partially around a portion of the outer housing 110. The cover 112 may be positioned over openings 114 extending radially through the outer housing 110. The cover 112 may be configured to break away from the outer housing 110 when fluid is received outward through the openings 114.

The tool 100 may include an inner mandrel 115 and a sleeve 116, which may be connected together and slidable within the bore 104. Further, the tool 100 may include a shear pin 117 connecting together the sleeve 116 and the outer housing 110, thereby temporarily preventing the sleeve 116 from moving. In addition, the sleeve 116 in the illustrated position may block communication between the bore 104 and the openings 114.

The tool 100 may include a ball seat 118, which may be of any shape suitable for engaging or “catching” an obstructing member (e.g., a ball or dart) deployed into the wellbore. The ball seat 118 may be connected to either or both of the inner mandrel 115 and the sleeve 116. When the obstructing member is caught by the ball seat 118, the bore 104 is plugged. A pressurized fluid behind the obstructing member may apply a force onto the obstructing member, and thus to the ball seat 118. This may then be transmitted as shearing force on the shear pin 117. Eventually, this may cause the shear pin 117 to yield, allowing the inner mandrel 115, the sleeve 116, and the ball seat 118 to slide downward (e.g., toward the lower sub 108) in the bore 104, thereby exposing the openings 114 and allowing communication from the bore 104 outwards to the exterior of the tool 100.

FIG. 2 illustrates an enlarged, cross-sectional view of the ball seat 118, according to an embodiment. The ball seat 118 may be at least partially constructed of a dissolvable material. The dissolvable material may be any material configured to dissolve in the presence of a certain fluid, for a certain amount of time, at a certain temperature, or any combination thereof. For example, the dissolvable material may start dissolving when exposed to a predetermined temperature and/or a predetermined fluid, such as wellbore fluid.

In some embodiments, the dissolvable material of the ball seat 118 may be or include a magnesium, thermoplastic, dissolvable aluminum, or a combination thereof. In other embodiments, the dissolvable material may be a matrix of two or more materials. The first material of the matrix may be configured to dissolve. The second material of the matrix may include non-dissolvable components, such as cast iron, ceramic (e.g., ceramic powder), sand, carbide, combinations thereof, or the like.

In some embodiments, during the forming process of the ball seat 118, the dissolvable material matrix may be ground to a shape. The ceramic powder (or another material harder than 40 Rockwell Hardness—C Scale) is mixed into the dissolvable material matrix. In another embodiment, the dissolvable material matrix may include dissolvable material and carbide. In another embodiment, the dissolvable material matrix is a powder metal mixture. For instance, the dissolvable material matrix may include a percentage of hardenable material, such cast iron, steel powder or steel flakes, and a percentage dissolvable material. The hardenable material may be hardened using induction heat treating or other common heat treating methods prior to or after being mixed within the dissolvable material matrix. The percentage of hardenable material may be from about 15 percent, about 20 percent, or about 25 to about 35 percent, about 40 percent, or about 50 percent, with the remainder of the power metal mixture being dissolvable material. The powder may include a portion of ceramic powder or sand.

Whether formed as a matrix or of a single component, the dissolvable material may be configured to dissolve within a wellbore fluid, e.g., generally within a predetermined amount of time. For example, introduction of a salt ion to the dissolvable material may result in the material dissolving. In some embodiments, such dissolving may not be desirable until treatment of the wellbore begins, which may be some time after the dissolvable component is deployed into the wellbore and potentially into contact with fluids that would dissolve the dissolvable material. Accordingly, the ball seat 118 may include one, two, or more protective layers, which may be configured to substantially prevent the dissolvable material from dissolving, at least temporarily, thereby stalling the dissolving process by preventing or at least slowing the wellbore fluids from reaching the dissolvable material. The protective layer(s) may be formed or applied during the manufacturing process of the dissolvable ball seat 118 or after the dissolvable ball seat 118 is placed in the tool 100. The protective layers may allow the dissolvable ball seat 118 to maintain integrity for predetermined amount of time (e.g., several months) or until the coating 202 is removed.

The protective layer(s) at least partially envelop the dissolvable material of the ball seat 118 and are thus configured to act as a barrier to prevent the degradation of the dissolvable ball seat 118 by isolating the dissolvable material thereof from direct temperature and/or fluid contact. One example of such a protective layer includes a treated outer surface layer 200 of the dissolvable material itself. For example, an outer surface 201 of the dissolvable material of the ball seat 118 may be anodized, such that the outer surface layer 200 of the dissolvable material forms an oxide (e.g., magnesium oxide), which may not be dissolvable. The treated outer surface layer 200 may be relatively thin, e.g., may extend to a depth (from the outer surface 201) of between about 0.20 mils and about 1.0 mils, e.g., between about 0.30 mils and about 0.60 mils. The outer surface layer 200 may form along an entirety of the outer surface 201 of the ball seat 118. In another embodiment, the outer surface layer 200 may extend along certain, targeted parts of the outer surface 201. For example, a mask may be applied, which may prevent the outer surface layer 200 from forming, or the outer surface layer 200 may be removed in certain locations after forming.

Another example of a protective layer includes a coating 202. The coating 202 may be a non-permeable and a non-dissolving coating that may not start to break down until the coating 202 comes in contact with (e.g., is eroded away by) a predetermined abrasive material or agitating material. The coating 202 may include a polymer (e.g., plastic, TEFLON®, and/or XYLAN®), a composite material, a paint, or combination thereof. The type of the coating 202 may be selected based upon the downhole temperature and/or the type of abrasive material used during the fracking operation. Further, the thickness of the coating 202 may be selected based upon the downhole temperature and/or the type of abrasive material used during the fracking operation. For example, the thickness of the coating 202 may be from 0.0625 inches, or about 0.1250 inches, or about 0.1875 inches to about 0.250 inches, about 0.3125 inches or about 0.375 inches. The coating 202 may be selected based upon predetermined factors and characteristics of the wellbore and/or the abrasive material.

As shown, the coating 202 may be applied over the treated outer surface layer 200. However, in other embodiments, the coating 202 may be used in lieu of treating the outer surface 201, and thus the treated outer surface layer 200 may not be provided. The coating 202 may be applied by spraying, brushing, immersion, or in any other suitable process. The protective coating 202 may cover all or a portion of the outer surface 201, may be targeted to certain areas of the ball seat 118, may be masked or removed from coating certain portions thereof, or the like. Although illustrated as having both the protective coating 202 and the treated outer layer 200, it is emphasized that this is merely one example. In other embodiments, the protective coating 202 may be omitted, and in still other embodiments, the treated outer layer 200 may be omitted.

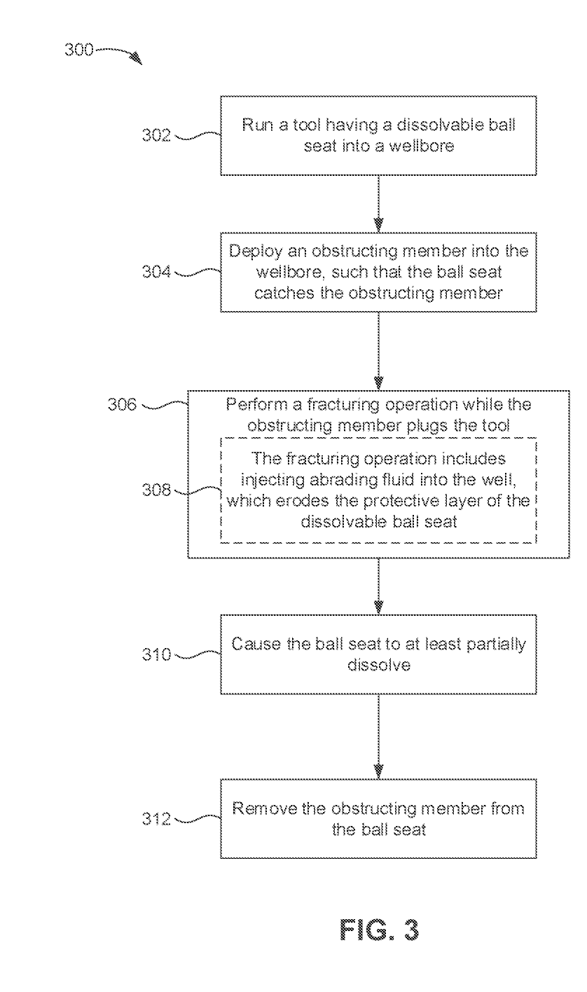

FIG. 3 illustrates a flowchart of a method 300 for hydraulic fracturing, according to an embodiment. The method 300 may include deploying or “running” a tool, such as the tool 100, into a wellbore, as at 302. Although the method 300 is described herein with reference to the tool 100, it will be appreciated that embodiments of the method 300 may employ other types of tools, and thus the method 300 should not be limited to any particular structure, unless otherwise specified herein. As provided by way of example above, and indicated at 302, the tool 100 run into the wellbore may include the ball seat 118, which may be made at least partially from a dissolvable material. In addition, the ball seat 118 may include one or more protective layers, e.g., either or both of the treated outer layer 200 and/or the protective coating 202.

The method 300 may include deploying an obstructing member (e.g., a ball, a dart, or the like) into the well, which may be engaged or “caught” by the ball seat 118, as at 304. The ball seat 118 catching the obstructing member may result in the bore 104 being obstructed, such that pressure communication axially across the tool 100 may be limited or prevented. Further, in some embodiments, the tool 100 catching the obstructing member in the ball seat 118 may cause the tool 100 to open the openings 114, which may allow communication radially outwards from the bore 104, through the openings 114.

The method 300 may include performing a fracturing operation, as at 306, e.g., while the obstructing member is caught in the ball seat 118. Such fracturing operations may include injecting high-pressure fracturing fluid into the wellbore, e.g., via the openings 114. The fluid may be pumped down from the top surface at pressure, and may be diverted through the openings 114 as the bore 104 is obstructed by the engagement between the obstructing member and the ball seat 118. Further, as indicated at 308, the fracturing operation at 306 may also at least initiate the process of eroding the protective layer(s) on the ball seat 118, as well as such protective layer(s) of any dissolvable components located above the ball seat 118 (e.g., in frac tools disposed between the tool 100 and the surface). For example, the fracturing fluid employed in the fracturing operations may provide the abrading fluid that removes at least a portion of the protective layer, thereby exposing the dissolvable material of the ball seat 118. Further, the dissolvable material may be dissolvable when contacted with the abrading material used in the fracturing operations. As such, the fracturing fluid, abrading fluid, and solvent may all be the same fluid, such that pumping the fluid down results in not only fracturing, but also erosion of the protective layer(s), and also dissolving of the ball seat 118. In other embodiments, these fluids may be different and separately pumped down, mixed together and pumped down, or the like.

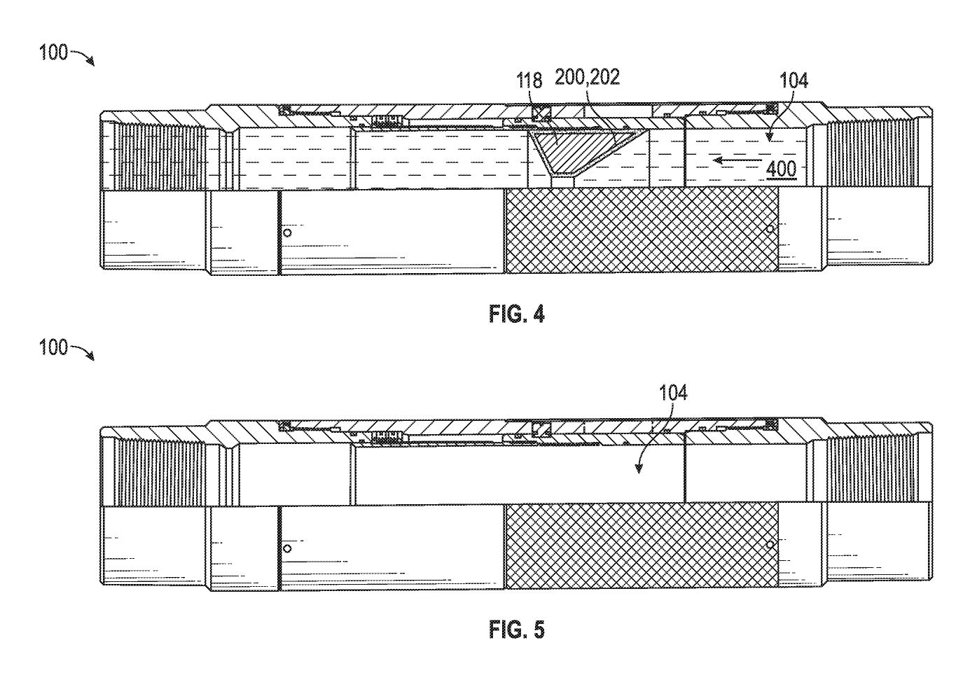

Moreover, it will be appreciated that the abrading fluid may be brought into contact with the ball seat 118 before, during, or after the obstructing member is caught in the ball seat 118. Referring now additionally to FIG. 4, the tool 100 is shown with the ball seat 118 generally intact, without an obstructing member in the bore 104. For example, in FIG. 4, the shear pin 117 is still intact, as well, and thus the openings 114 may not have been opened. In other embodiments, the openings 114 may have been opened via engagement with the obstructing member, as explained above.

As shown, the abrading fluid 400 may enter into the bore 104 and impinge on the ball seat 118. The abrading fluid 400 may include abrasive material such as sand, grit, acids, salts, proppant, etc. The abrading fluid 400 may contact the ball seat 118 and may erode, abrade, wear down, or otherwise at least partially remove the protective layer(s) (e.g., the treated outer layer 200 and/or the coating 202) from the ball seat 118. The abrading fluid may also include a fluid that dissolves the dissolvable material of the ball seat 118.

Once the protective layer(s) are at least partially removed, the dissolvable material of the ball seat 118 is exposed to the solvent fluid (e.g., the abrading fluid, which may also be the fracturing fluid), causing in the ball seat 118 to dissolve, as at 310. FIG. 5 shows the tool 100 with the ball seat 118 having been removed through dissolving, thereby removing the restriction to the inner diameter of the bore 104. In accordance with a description of the protective layers as “substantially preventing” the dissolvable material from dissolving, it will be appreciated that the ball seat 118 may begin to dissolve before the entirety of the protective layer(s) are removed, and that the protective layer(s) may not be effective at stopping all dissolving of the dissolvable material prior to removal, and thus some dissolving may occur beforehand.

The method 300 may then include removing the obstructing member from the ball seat 118, as at 312. This may occur using a flow-back operation, in which the direction of flow is reversed and proceeds up through the tool 100, toward the surface, thereby lifting the obstructing member away from the ball seat 118. In other embodiments, the obstructing member may be dissolvable and removed by contacting the obstructing member with a predetermined fluid for a predetermined time, resulting in the obstructing member at least partially dissolving and thus failing to obstruct the bore 104. The predetermined fluid may be the fracturing fluid (which, again, may also be the abrading fluid and/or the solvent for the ball seat 118). Accordingly, removing the obstructing member may occur before, during, or after the fracturing operation (e.g., before, during, or after eroding and/or dissolving the ball seat 118).

In some embodiments, a plurality of tools each having a dissolvable component may be provided, consistent with the method 300. In such embodiments, the protective layer(s) of the components may vary. For example, the tool deployed the farthest into the well may have the thinnest protective layer (this could also mean that it has fewer layers, omits the coating or the treated outer layer, etc.). Each successive tool, proceeding uphole, may have a thicker (or otherwise more efficacious) protective layer. As such, when the deepest tool is plugged, and fracturing operations commenced, the dissolvable components of the tools above may be delayed from dissolving, in comparison to the deepest component. As the tools are successively plugged and employed to divert fracturing fluid, the ball seats of the tools below may be substantially dissolved, while those above may remain substantially intact.

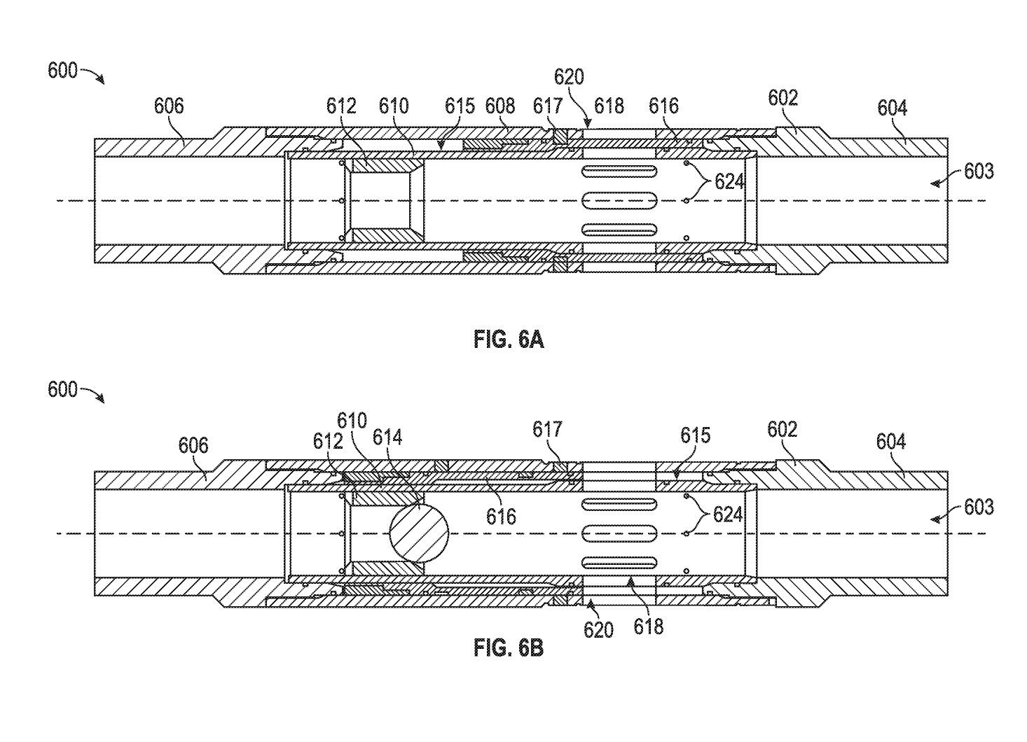

FIGS. 6A and 6B illustrate side, half-sectional views of another downhole tool 600, according to an embodiment. The tool 600 may be similar in structure and function to the tool 100 discussed above with respect to FIGS. 1-5. In particular, the tool 600 may include a body 602 in which a bore 603 is defined extending axially therethrough. In an embodiment, the body 602 may include an upper sub 604, a lower sub 606 that is coaxial with and separated apart from the upper sub 604, and an outer housing 608 extending between and connecting together the upper and lower subs 604, 606.

The tool 600 may include an inner mandrel 610 that may be positioned within the bore 603. A ball seat 612 may be positioned within the inner mandrel 610, so as to catch an obstructing member 614, as shown in FIG. 6B. The ball seat 612 may include one or more protective layers, such as the treated outer layer 200 and/or the protective coating 202, as discussed above with respect to the ball seat 118 (see, e.g., FIG. 2). In some embodiments, the obstructing member 614 may also or instead have the one or more protective layers, and may include a dissolvable material at least partially enveloped by the one or more protective layers, e.g., as discussed with respect to the ball seat 118.

In the illustrated embodiment, the inner mandrel 610 may be separated radially apart from the outer housing 608, such than an annular chamber 615 is defined therebetween. A sliding sleeve 616 may be positioned in the annular chamber 615. In some embodiments, the sliding sleeve 616 may be dissolvable and may include a protective layer, as discussed above for the ball seat 118. Further, the inner mandrel 610 may define openings 618 extending radially therethrough, which may be aligned with openings 620 extending radially through the outer housing 608. The sliding sleeve 616 may be slidable between a first position, in which the sliding sleeve 616 blocks fluid communication between the openings 618, 620, and a second position, in which the sliding sleeve 616 allows fluid communication therebetween. Moreover, when the sliding sleeve 616 is in the second position, fluid communication between the bore 603 and an exterior of the tool 600 may be provided via the openings 618, 620.

In some embodiments, the sliding sleeve 616 may initially be secured to the outer housing 608 via a shear pin 622. The inner mandrel 610 may also include pressure ports 624, which may communicate with the annular chamber 615, above the sliding sleeve 616. When the pressure is sufficiently high in the bore 603, the pressure applies a downward force on the sliding sleeve 616, which breaks the shear pin 622 and pushes the sliding sleeve 616 from the first position (FIG. 6A) to the second position (FIG. 6B).

Accordingly, in operation, the obstructing member 614 may be deployed and caught by the ball seat 612, thereby blocking the bore 603. The pressure in the bore 603 may be increased until the sliding sleeve 616 shifts open and allows communication radially outward, e.g., for fracturing operations. The obstructing member 614 may then be removed from the tool 600, e.g., by reversing fluid flow. An abrading fluid, which could be the same fluid as was expelled through the openings 618, 620 as part of the fracturing operation, is then introduced to the ball seat 612 (before or after removing the obstructing member). The abrading fluid erodes the protective layer(s) from the ball seat 118, exposing the dissolvable material of the ball seat 612. The abrading fluid, or another solvent fluid, is then introduced to the dissolvable material of the ball seat 612, causing the ball seat 612 to at least partially dissolve. Once at least partially dissolved, the ball seat 612 may fall away from the tool 600, allowing for full inner bore diameter to be achieved, e.g., without milling out the ball seat 612.

Additional details of some embodiments of the tool 600 may be as provided in U.S. Pat. No. 8,915,300, which is incorporated herein by reference in its entirety to the extent not inconsistent with the present disclosure.

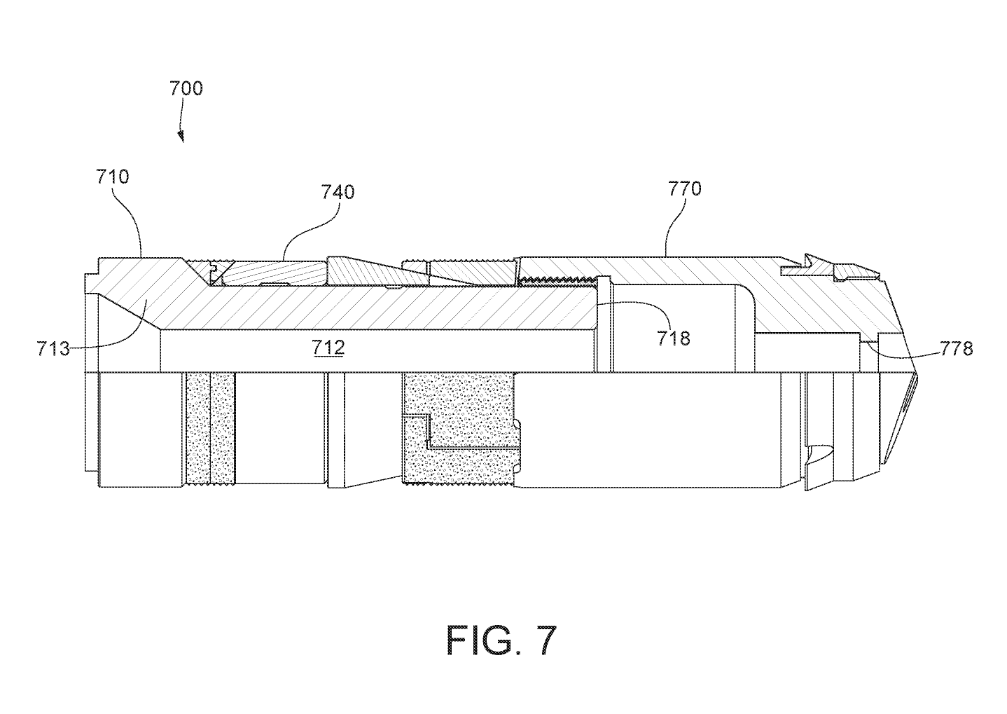

FIG. 7 illustrates a side, half-sectional view of another downhole tool 700, according to an embodiment. The downhole tool 700 may, in an embodiment, be a plug (e.g., a frac plug) and may thus not include a sleeve or opening; however, in other embodiments, sleeves and/or openings may be provided.

The tool 700 may include a mandrel 710 which may define a bore 712 therethrough. Further, the tool 700 may include a ball seat 713, which may be formed as part of the mandrel 710, or may be a separate part that is connected to the mandrel 710. The ball seat 713 (and/or any other part of the mandrel 710) may be at least partially constructed of a dissolvable material or matrix, as discussed above with reference to the ball seat 118. Further, the ball seat 713 and/or any other portion of the mandrel 710 may include one or more protective layer(s), such as the treated outer layer 200 and/or the protective coating 202 (see, e.g., FIG. 2). The ball seat 713 may be configured to catch and engage an obstructing member, so as to block the bore 712 and allow for fracturing operations above the tool 700.

The tool 700 may also include a setting assembly 720 and one or more sealing elements 740 positioned around the mandrel 710. In addition, the tool 700 may include a shoe 770, which may include a shearable portion 778. Accordingly, the tool 700 may be a “bottom-set” plug, in which a setting tool is connected to the shoe 770 via the shearable portion 778. To set the tool 700, the setting tool pulls upwards on the shoe 770 and a setting sleeve pushes downwards against the mandrel 710. Additional details of some embodiments of the tool 700 may be as provided in U.S. Provisional Patent Application having Ser. No. 62/374,299, which is incorporated herein by reference in its entirety to the extent not inconsistent with the present disclosure.

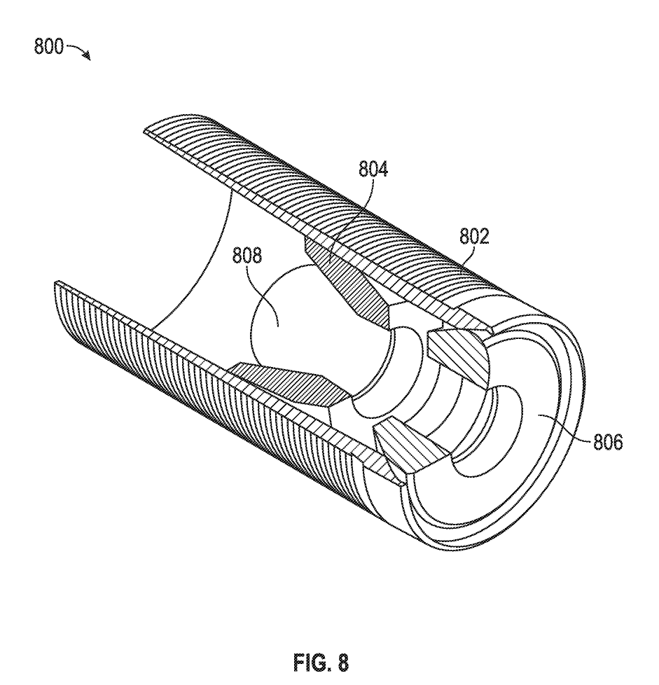

FIG. 8 illustrates a perspective, quarter-sectional view of another tool 800, according to an embodiment. The tool 800 may be also be a plug for plugging a wellbore, but may be of the expanding sleeve variety. More particularly, the tool 800 may include an expandable sleeve 802 and one or more swages (two shown: 804, 806) disposed therein. When the swages 804, 806 are moved within the expandable sleeve 802, the swages 804, 806 may be configured to expand the sleeve 802 radially outwards, such that the sleeve 802 engages and, e.g., bites into a surrounding tubular (e.g., a casing, a liner, or the wellbore wall).

In some embodiments, one of the swages (in this case, the swage 804) also serves as a ball seat. As shown, the swage 804 providing the ball seat may thus be configured to catch an obstructing member 808, so as to plug the tool 700. The swage 804 and/or any other component of the tool 800 (e.g., the sleeve 802 and/or other swages 804) may be at least partially made from a dissolvable material, as described above for the ball seat 118 with reference to FIG. 2. Accordingly, the swage 804 (or other dissolvable component) may also include one or more protective layer(s), such as the treated outer layer 200 and/or the protective coating 202 (e.g., FIG. 2), on all or a portion of the dissolvable component. Accordingly, in use, the abrading fluid may be employed to erode the protective layer(s) so as to expose the dissolvable material, and the dissolvable component may be dissolved. Additional details of some embodiments of the tool 800 may be as described in U.S. patent application having Ser. No. 15/217,090, which is incorporated herein by reference to the extent not inconsistent with the present disclosure.

As used herein, the terms “inner” and “outer”; “up” and “down”; “upper” and “lower”; “upward” and “downward”; “above” and “below”; “inward” and “outward”; “uphole” and “downhole”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”

The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method for fracturing a well, comprising:
running downhole tool into a wellbore, the downhole tool comprising a ball seat including a dissolvable material and a protective layer that substantially prevents the dissolvable material from dissolving;
deploying an obstructing member into the wellbore, wherein the obstructing member is caught by the ball seat;
performing one or more fracturing operations while the obstructing member engages the ball seat, wherein performing the one or more fracturing operations comprises introducing an abrading fluid to the ball seat, and wherein the abrading fluid erodes at least a portion of the protective layer from the ball seat; and
after eroding the at least a portion of the protective layer, causing the dissolvable material of the ball seat to at least partially dissolve.

2. The method of claim 1, wherein the abrading fluid comprises frac sand, proppant, or both.

3. The method of claim 1, wherein the abrading fluid dissolves the dissolvable material after the protective layer is eroded.

4. The method of claim 1, wherein performing the one or more fracturing operations comprises injecting the abrading fluid into a formation.

5. The method of claim 1, wherein the protective layer comprises a treated outer layer of the ball seat.

6. The method of claim 5, wherein the treated outer layer comprises an oxide of the dissolvable material.

7. The method of claim 1, wherein the protective layer comprises a coating applied to the ball seat.

8. The method of claim 7, wherein the coating comprises a polymer.

9. The method of claim 1, wherein the protective layer comprises:
a treated outer layer of the ball seat; and
a protective coating applied to the treated outer layer of the ball seat.

10. The method of claim 1, wherein the dissolvable material comprises a dissolvable material matrix comprising at least one of cast iron, ceramic powder, sand, and carbide.

11. The method of claim 10, wherein the dissolvable material matrix further comprises magnesium, thermoplastic, aluminum, or a combination thereof.

12. A downhole tool, comprising:
a dissolvable component comprising a dissolvable material and at least one protective outer layer at least partially enveloping the dissolvable material, wherein the at least one protective outer layer is configured to be eroded by an abrading fluid so as to allow introduction of the abrading fluid to the dissolvable material, wherein the dissolvable material dissolves in the presence of the abrading fluid.

13. The downhole tool of claim 12, further comprising a body defining a bore therethrough, wherein the dissolvable component comprises a ball seat positioned within the bore of the body, the ball seat being configured to catch an obstructing member, so as to plug the bore of the body.

14. The downhole tool of claim 12, wherein the body defines one or more openings therein, and wherein the ball seat catching the obstructing member causes the one or more openings to allow fluid communication from a bore of the body to an exterior of the tool.

15. The downhole tool of claim 14, wherein the body comprises an outer housing defining a first opening of the one or more openings, and an inner mandrel positioned within the outer housing and defining a second opening of the one or more openings, the downhole tool further comprising a sliding sleeve positioned between the inner mandrel and the outer housing, wherein the sliding sleeve is slidable between a first position in which the slidable sleeve prevents fluid communication between the first and second openings, and a second position in which the slidable sleeve permits fluid communication between the first and second openings.

16. The downhole tool of claim 12, wherein the at least one protective layer comprises a treated outer surface layer of the dissolvable material, and wherein the treated outer surface layer comprises an oxide of the dissolvable material, wherein the oxide is not dissolvable in a fluid configured to dissolve the dissolvable material.

17. The downhole tool of claim 12, wherein the at least one protective layer comprises a polymer.

18. The downhole tool of claim 12, wherein the dissolvable material comprises a matrix including magnesium, a thermoplastic, or a combination thereof, and cast iron, a ceramic, sand, a carbide, or a combination thereof.

19. The downhole tool of claim 12, wherein the dissolvable component comprises a mandrel, the tool further comprising a setting assembly and one or more seals positioned around the mandrel.

20. A method of removing a component in a wellbore, the method comprising:
deploying the component into the wellbore, the component comprising a dissolvable material and a protective layer at least partially enveloping the dissolvable material, wherein the protective layer substantially prevents the dissolvable material from dissolving until the protective layer is at least partially removed by an abrading fluid;
pumping the abrading fluid into the wellbore to remove at least a portion the protective layer of the component; and
removing the component by dissolving the dissolvable material exposed by removing the at least a portion of the protective layer.

21. The method of claim 20, wherein the component is a ball or a dart.
